(19) United States
(12) Patent Application Publication
(10) Pub. No.: US 2024/0022659 A1
(43) Pub. Date: Jan. 18, 2024

(54) KEYBOARD FOR A STEERING WHEEL

(71) Applicant: Yair LANDAU, Maor (IL)

(72) Inventor: Yair LANDAU, Maor (IL)

(21) Appl. No.: 18/034,751

(22) PCT Filed: Nov. 4, 2021
(86) PCT No.: PCT/IL2021/051311

§ 371 Date: May 1, 2023

Related U.S. Application Data
(60) Provisional application No. 63/110,089, filed on Nov. 5, 2020.

(51) Int. Cl. H04M 1/72409; G06F 3/02; H04M 1/72436; H04M 1/72463; H04M 1/04; H04M 1/72466; B62D 1/04

(52) U.S. Cl. CPC H04M 1/724098; G06F 3/0219; G06F 3/0227; H04M 1/72436; H04M 1/724631; H04M 1/04; H04M 1/72466; B62D 1/046

(57) ABSTRACT

Disclosed herein is a keyboard for a steering wheel of a car. The keyboard includes a first unit and a second unit configured to be mounted on the back of a steering wheel on a right side-arm and a left side-arm of the steering wheel, respectively. The first unit and second units are configured so as to enable a driver to type thereon using their hands, while grasping the steering wheel. The keyboard is thereby configured to facilitate blind typing thereon by a seated driver.

### TECHNICAL FIELD

The present disclosure relates generally to keyboards for steering wheels.

### BACKGROUND

“Texting while driving” or “texting and driving” are expressions coined for the sending and/or reading of text messages by a driver. Perhaps the biggest problems, associated with typing text messages while driving, are the removal of at least one hand from the steering wheel in order to type a message on the cellphone and the shifting of the gaze from the road onto the cellphone, which is typically mounted to the side of the steering wheel. Nevertheless, many drivers use their cellphones to send and read text messages while driving, even in jurisdictions where it is prohibited. This being the case, a technical solution, which will allow a driver to safely type messages while driving, may be beneficial.

### SUMMARY

The present disclosure addresses the above-mentioned problems by providing a keyboard for a steering wheel of a car, which is safe to use in the sense that the driver does not have to remove any one of their hands from the steering wheel in order to type nor shift their gaze off the road.

According to an aspect of some embodiments, there is provided a keyboard for a steering wheel for use while driving. According to some embodiments, the keyboard may be installed or mounted on the steering wheel, such that at least a part thereof is positioned on the back of the steering wheel, i.e. the side of the steering that faces away from the driver (and which the driver does not see when seated in the driver's seat). The keyboard may be used in conjunction with a smartphone, which may be mounted slightly above the steering wheel, such that the driver's view of the road is, or practically is, unobstructed. Text typed on the keyboard may be displayed on the screen of the smartphone.

According to some embodiments, the keyboard may include two units (i.e. two boards, which may include different keys): A first unit may be positioned on the right side of the steering wheel, on the back side thereof, and a second unit may be positioned on the left side of the steering wheel, on the back side thereof. The first unit is positioned such as to allow a driver to type thereon using one or more of the index, middle, ring, and little fingers of the right hand, while the right hand grasps the steering wheel. Similarly, the second unit is positioned such as to allow a driver to type thereon using one or more of the index, middle, ring, and little fingers of the left hand, while the left hand grasps the steering wheel.

Several different keyboard layouts (i.e. arrangement of the keys on the keyboard) are disclosed. According to some embodiments thereof, the disclosed keyboard layouts allow a driver to blindly type based on visual memory of a standard computer keyboard or a virtual smartphone keyboard, or tactile memory of a standard computer keyboard. Thus, advantageously, these keyboard layouts require little to no memorization of the arrangement of the keys on the part of the driver.

Thus, according to an aspect of some embodiments, there is provided a keyboard for a steering wheel of a car. The keyboard includes a first unit and a second unit configured to be mounted on the back of a steering wheel on a right side and a left side of the steering wheel, respectively. The first unit is positioned and configured so as to enable a driver to type thereon using a right hand thereof, while the right hand is grasping the steering wheel. The second unit is positioned and configured so as to enable a driver to type thereon using a left hand thereof, while the left hand is grasping the steering wheel. (i) The first unit and the second unit constitute complementary parts of a keyboard whose keys are arranged in a mirror image of a standard computer keyboard or virtual smartphone keyboard, or (ii) the first unit includes three columns of letters keys arranged in a first pattern, which is related to the arrangement of letter keys on a right half of a standard computer keyboard by about a 90° clockwise rotation, and the second unit includes three columns of letter keys arranged in a second pattern, which is related to the arrangement of letters keys on a left half of a standard computer keyboard by about a 90° anti-clockwise rotation. The keyboard is thereby configured to facilitate blind typing thereon by a seated driver.

According to some embodiments, wherein the first unit and the second unit constitute complementary parts of a keyboard whose keys are arranged in a mirror image of a standard computer keyboard or virtual smartphone keyboard, the first unit and the second unit constitute complementary parts of a keyboard whose keys are arranged in a mirror image of a QWERTY keyboard.

According to some embodiments, the first unit is positioned and configured to enable the driver to type thereon using one or more of the second to fifth digits of the right hand (i.e. the index, middle, ring, and little finger of the right hand), and the second unit is positioned and configured to enable the driver to type thereon using one or more of the second to fifth digits of the left hand (i.e. the index, middle, ring, and little finger of the left hand).

According to some embodiments, the first unit is configured to be mounted on the back of the steering wheel on a right side-arm of the steering wheel, and the second unit is configured to be mounted on the back of the steering wheel on a left side-arm of the steering wheel.

According to some embodiments, one or more letter keys on each of the first unit and the second unit have imprinted thereon a raised impression of the respective letter, thereby facilitating tactile identification of the letter key.

According to some embodiments, the keyboard is configured to be communicatively associated with a mobile computational device.

According to some embodiments, the keyboard further includes a wireless communication unit (e.g. a Bluetooth antenna).

According to some embodiments, the first unit and/or the second unit includes navigation and selection keys.

According to some embodiments, the first unit and/or the second unit includes specialized function keys including one or more of ‘read message’, ‘send message’, and ‘delete message’.

According to some embodiments, each of the first and second units is removably mountable on the back of the steering wheel (e.g. using Velcro).

According to some embodiments, each of the first and second units is flexible so as to conform to a range of shapes and/or dimensions of steering wheel backsides.

According to some embodiments, each of the first and second units is or includes a touch surface.

According to some embodiments, each of the first and second units is functionally associated with a car computer via electronic circuitry (e.g. processing circuitry) in the first and second units.

According to some embodiments, the electronic circuitry is configured to receive from the car computer driving parameters and based thereon enable or disable typing on the keyboard.

According to some embodiments, the driving parameters include a driving mode (i.e. whether the car is in an autonomous or semi-autonomous driving mode) and a driving speed.

According to some embodiments, the first and second units are built-in into the right side-arm and left side-arm backsides, respectively.

According to some embodiments, the first unit and second unit are interconnected (so as to constitute a single composite unit).

According to an aspect of some embodiments, there is provided a steering wheel of a car. The steering wheel has a built-in keyboard as described above.

According to an aspect of some embodiments, there is provided a keyboard assembly for a steering wheel of a car. The keyboard assembly includes:
A keyboard as described above, wherein the keyboard is configured to be communicatively associated with a mobile computational device.
A mobile computational device, communicatively associated with the keyboard and configured to display on a screen thereof text typed on the keyboard.

According to some embodiments, wherein the first unit and/or the second unit includes navigation and selection keys, the mobile computational device is further configured to allow use of functions thereof using the navigation and selection keys.

According to some embodiments, the functions include displaying a received message and sending of a typed text.

According to an aspect of some embodiments, there is provided a keyboard assembly for a steering wheel of a car. The keyboard assembly includes:
A keyboard as described above, wherein the keyboard is configured to be communicatively associated with a mobile computational device.
A computer-readable storage medium having stored thereon software—e.g. a downloadable (keyboard-associated) app—which when executed by a processor of a mobile computational device communicatively associated with the keyboard, causes the mobile computational device to display on a screen thereof text typed on the keyboard.

According to some embodiments, the mobile computational device is a smartphone.

According to some embodiments, wherein the first unit and/or the second unit includes navigation and selection keys, the software is further configured to enable use of at least some of the smartphone functions using the navigation and selection keys.

According to some embodiments, the at least some smartphone functions include displaying a received message and sending of a typed text.

According to some embodiments, the at least some smartphone functions include selection of in-app commands of a third-party app having messaging capabilities.

According to some embodiments, the software is configured to display on the screen of the smartphone text from the third-party app in a customized format.

According to some embodiments, the customized format incorporates a horizontal layout (i.e. landscape orientation).

According to some embodiments, the at least some smartphone functions include selection of any one of a plurality of third-party apps having messaging capabilities.

According to some embodiments, the plurality of third-party apps include an email app(s), an instant messaging app(s), and/or a social media app(s).

According to some embodiments, the software enables changing functionality of keys on the keyboard.

According to some embodiments, the software enables selecting and changing a language of the keyboard.

According to an aspect of some embodiments, there is provided a keyboard assembly for a steering wheel of a car. the keyboard assembly includes:
A keyboard as described above, wherein the keyboard is configured to be communicatively associated with a mobile computational device.
A stand installable between a steering wheel and a front windshield of the car. The stand is configured for detachable mounting thereon of a mobile computational device, such that a seated driver's view of a road through the front windshield is unobstructed, or minimally obstructed.

According to some embodiments, wherein the mobile computational device is a smartphone, the stand is configured for horizontal mounting of the smartphone.

According to some embodiments, the stand is configured to be installable on a dashboard of the car and/or on the front windshield.

According to some embodiments, a height of the stand is adjustable.

According to some embodiments, the keyboard assembly further includes a computer-readable storage medium as described above.

According to an aspect of some embodiments, there is provided a keyboard assembly for a steering wheel of a car. The keyboard assembly includes:
A keyboard as described above, wherein the keyboard is configured to be communicatively associated with a mobile computational device.
A pointing device mountable on a steering wheel such as to be controllable by a thumb of one of the hands of the driver when the second to fifth digits of the hand are positioned on the one of the first and second units. The pointing device has at least computer mouse navigation capabilities.

According to some embodiments, the pointing device is configured to be positioned on a corner formed by an upper portion of the steering wheel and a side-arm of the steering wheel.

According to some embodiments, the keyboard assembly further includes a stand as described above.

According to some embodiments, the keyboard assembly further includes a computer-readable storage medium as described above.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A presents a schematic view of a steering wheel keyboard, including a first unit and a second unit, installed on a steering wheel, according to some embodiments;

FIG. 1B presents a schematic front view of the first unit of the keyboard of FIG. 1A, according to some embodiments;

FIG. 1C presents a schematic front view of the second unit of the keyboard of FIG. 1A, according to some embodiments;

FIGS. 1D and 1E schematically depict a pointing and clicking assembly, configured for use in conjunction with the keyboard of FIG. 1A, according to some embodiments;

FIG. 1F presents a schematic front view of the steering wheel of FIG. 1A, with the keyboard of FIG. 1A installed thereon, according to some embodiments;

FIG. 2 presents a perspective view of a driver, driving while typing on the keyboard of FIG. 1A, according to some embodiments;

FIG. 3A presents a schematic view of a steering wheel keyboard, including a first unit and a second unit, installed on a steering wheel, according to some embodiments;

FIG. 3B presents a schematic front view of the steering wheel of FIG. 3A, with the keyboard of FIG. 3A installed thereon, according to some embodiments; and

FIGS. 4A and 4B presents schematic front views of a first unit and a second unit, respectively, of a steering wheel keyboard, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

As used herein, the pronoun “they” may be used as a third-person, singular pronoun when the gender is unspecified. Similarly, derivatives of “they”, particularly, “their” and “themself” may be used as the genderless equivalents of “his/hers” and “himself/herself”, respectively.

As used herein, the term “fingers” is reserved for the index, middle, ring, and little fingers, and, in particular, does not refer to any of the thumbs. The term “hand digits” may be used to refer to both the fingers and the thumb.

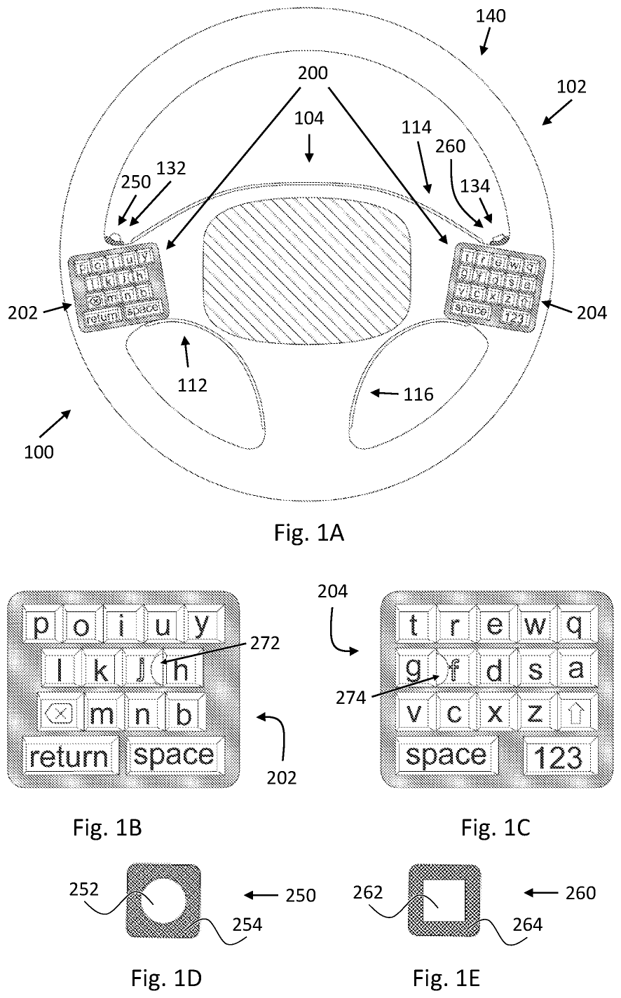

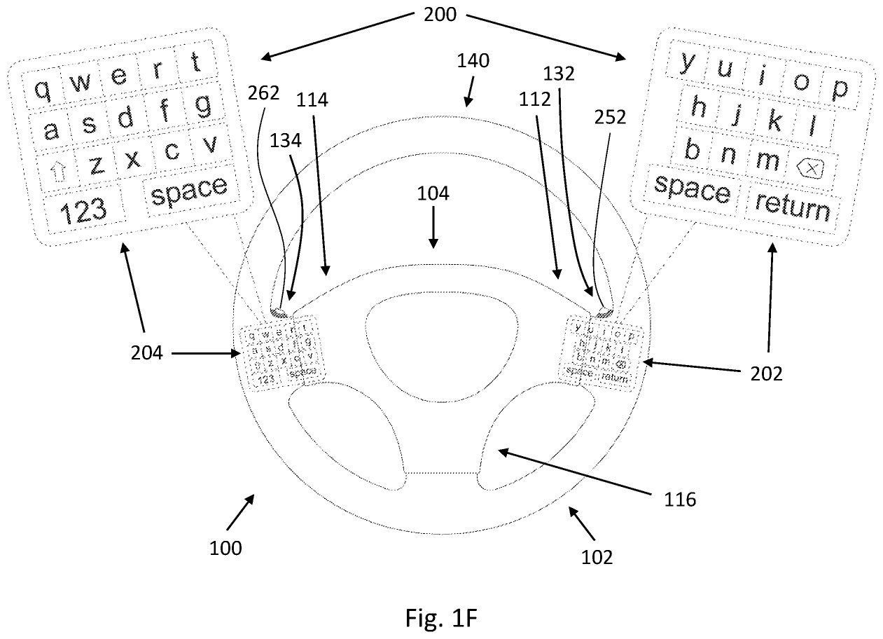

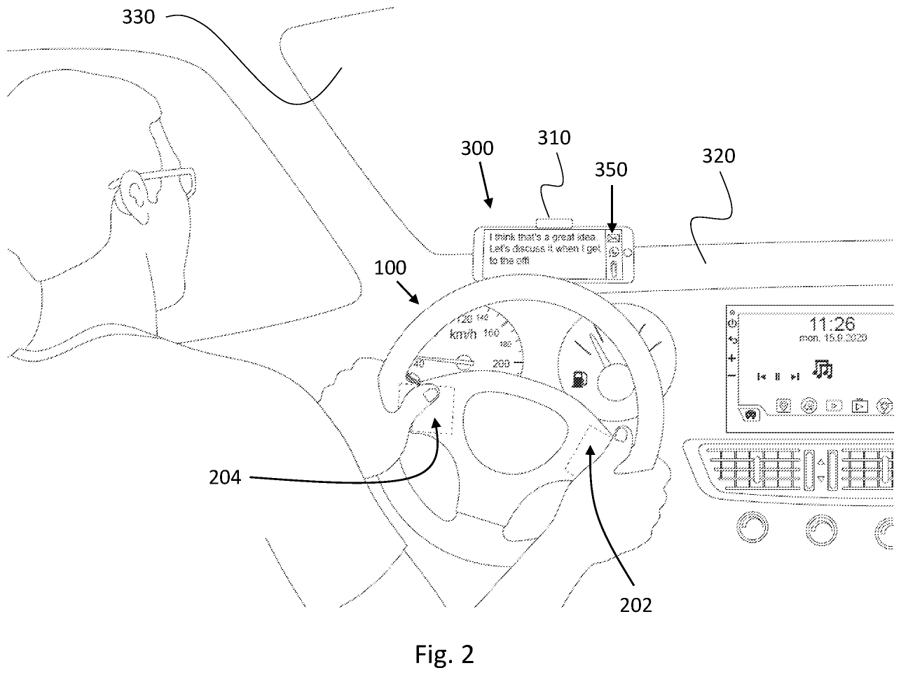

As used herein, here the terms “front” and “back”, with reference to a steering wheel (such as the steering wheel of FIGS. 1A, 1F, 2, 3A, and 3B), are employed in the same manner that a driver (such as the driver of FIG. 2) would employ the terms. Thus, the front of a steering wheel refers to the part of the steering wheel, which faces the driver—when the driver is (seated) in the driver's seat (e.g. while driving)—and which the driver sees. The back of the steering wheel refers to the part of the steering wheel, which is hidden-from-view from the driver when the driver is seated in the driver's seat.

According to an aspect of some embodiments, depicted in FIGS. 1A-1C and FIG. 1F, there is provided a keyboard 200 for a steering wheel. FIG. 1A presents a schematic back view of a steering wheel 100 with keyboard 200 mounted thereon, according to some embodiments. Steering wheel 100 includes a wheel 102, a central part 104, a first side-arm 112, a second side-arm 114, and may also include a base arm 116 (i.e. a bottom or lower arm). Each of arms 112, 114, and 116 extends from central part 104 to wheel 102. First side-arm 112 and second side-arm 114 extend sideways in opposite, or substantially opposite, directions from central part 104.

Keyboard 200 includes a first unit 202 (i.e. a first keyboard unit), mounted in part or fully on first side-arm 112, and a second unit 204 (i.e. a second keyboard unit), mounted in part or fully on second side-arm 114. According to some embodiments, and as depicted in FIGS. 1A and 1F, first unit 202 is shown mounted on the backside (i.e. the back surface) of first side-arm 112 and the backside of the segment of wheel 102 to which first side-arm 112 connects. Similarly, second unit 204 is shown mounted on the backside of second side-arm 114 and the backside of the segment of wheel 102 to which second side-arm 114 connects.

According to some embodiments, units 202 and 204 are attachable onto the backside of steering wheel 100. According to some such embodiments, the precise positioning of units 202 and 204 on the backside of steering wheel 100 may be chosen by the driver, e.g. according to their comfort, thereby accommodating differences between drivers in hand anatomy, such as the size of the hands, and the length of the fingers.

Referring also to FIG. 1B, an enlarged front view of first unit 202 is presented, according to some embodiments. Referring also to FIGS. 1C, an enlarged front view of second unit 204 is presented, according to some embodiments. Each of units 202 and 204 may be shaped as a sheet (e.g. a rectangular sheet). According to some embodiments, the front surfaces of each of units 202 and 204 may include protruding (i.e. slightly projecting from the surface) keys, as depicted in the figures, flat keys, or may include a touch surface. According to some embodiments, each of units 202 and 204 may be flexible (e.g. similarly to a roll up keyboard) such as to conform to different shapes of the (steering wheel) side-arm backsides and, optionally, wheel backsides, and thereby allow mounting of units 202 and 204 on different steering wheels (e.g. of different car manufacturers).

According to some embodiments, units 202 and 204 may be removably attached to the backside of steering wheel 100. For example, a Velcro loop surface may be included on, or attached to, the back surface of first unit 202 and a corresponding Velcro hook surface may be attached to first side-arm 112 backside and, optionally, the backside of the segment of wheel 102 to which first side-arm 112 connects. Similarly, a Velcro loop surface may be included on, or attached to, the back surface of second unit 204 and a corresponding Velcro hook surface may be attached to second side-arm 114 backside and, optionally, the backside of the segment of wheel 102 to which second side-arm 114 connects.

The use of Velcro surfaces allows easily changing and adjusting the positions of each units 202 and 204. Advantageously, this may allow different drivers (e.g. a couple who shares the same car) to conveniently and safely use keyboard 200 while driving.

Alternatively, according to some embodiments, units 202 and 204 may be permanently attached to the backside of steering wheel 100, e.g. by gluing or by screw-mechansims.

According to an aspect of some embodiments, not depicted in the figures, there is provided a steering wheel manufactured to incorporate units, similar to units 202 and 204, on the backside of the steering wheel (such as to be positioned thereon essentially as depicted in FIG. 1A). That is to say, the steering wheel may be manufactured with a keyboard, similar to keyboard 200, already built-in, on the backside of the steering wheel, in essentially the same manner that steering wheel controls (i.e. control buttons), such as cruise controls and/or audio controls, are nowadays built-in into the front surfaces of the arms of the steering wheel in some cars.

Referring again to FIGS. 1B and 1C, and considering both first unit 202 and second unit 204 together, with second unit 204 positioned to the right of first unit 202, it is seen that the two units constitute complementary parts of a keyboard whose keys are arranged in a mirror image of a QWERTY keyboard, such as the virtual QWERTY keyboard employed on smartphones (as a non-limiting example, an iPhone). More precisely, the positions of the keys are inverted relative to the positions thereof in a QWERTY keyboard, such that the letter ‘p’ is positioned where the letter ‘q’ would be positioned on the QWERTY keyboard (i.e. the letters ‘p’ and ‘q’ are switched), the letter ‘o’ is positioned where the letter ‘w’ would be positioned on the QWERTY keyboard (i.e. the letters ‘o’ and ‘w’ are switched), the letter ‘j’ is positioned where the letter ‘f’ would be positioned on the QWERTY keyboard (i.e. the letters ‘j’ and ‘f’ are switched), and so on.

According to some embodiments, second unit 204 (as depicted in FIG. 1C) and/or first unit 202 may include a ‘123’ key. To revert to a numbers and symbols keyboard layout, the ‘123’ key may be pressed. Pressing again the ‘123’ key switches back to the letters keyboard layout.

Referring also to FIG. 1F, FIG. 1F presents a schematic front view of steering wheel 100 with keyboard 200 mounted thereon on the backside thereof, according to some embodiments. Even though units 202 and 204 would not be visible in a front view (and would not be visible to a seated driver), they are nevertheless outlined (in a dashed line) to facilitate the description. Considered as a single keyboard, in FIG. 1F keyboard 200 is inverted relative to a driver seated in front of steering wheel 100. The front surfaces of each of first unit 202 and second unit 204 face away from the driver. (Since first unit 202 and second unit 204 are attached on the back surfaces thereof to the backside of steering wheel 100.) In particular, the keys on first unit 202 and second unit 204 face away (e.g. protrude away) from the driver.

According to some embodiments, and as depicted in FIGS. 1A, 1F, and 2, keyboard 200 may be used in conjunction with a pointing and clicking assembly, which provides the same functionality as a computer mouse. The pointing and clicking assembly includes a pointing device 250, shown also in FIG. 1D, and a clicking device 260, shown also in FIG. 1E.

FIG. 1D provides a schematic front view of pointing device 250, according to some embodiments. As a non-limiting example, and as depicted in FIG. 1D, pointing device 250 may include a trackball 252 and a pointing device surface 254 (i.e. a flexible pad or pad-like surface) on which trackball 252 is positioned. Pointing device surface 254 is configured to allow mounting pointing device 250 on steering wheel 100 and, in particular, in any of the two corners formed by a wheel upper portion 140 (i.e. an upper portion of wheel 102) and first side-arm 112 and second side-arm 114, respectively. In FIG. 1A and 1F, pointing device 250 is mounted on a first corner 132 (formed by wheel upper portion 140 and first side-arm 112), thereby enabling the driver to employ their right thumb to maneuver trackball 252.

FIG. 1E provides a schematic front view of clicking device 260, according to some embodiments. As a non-limiting example, and as depicted in FIG. 1E, clicking device 260 may include a pressable (i.e. clickable) button 262 and a clicking device surface 264 on which button 262 is positioned. Clicking device surface 264 is similar to pointing device surface 254 and, in particular, similarly mountable on steering wheel 100. In FIGS. 1A and 1F, clicking device 260 is mounted on a second corner 134 (formed by wheel upper portion 140 and second side-arm 114), thereby enabling the driver to employ their left thumb to click on button 262.

According to some alternative embodiments, not depicted in the figures, pointing device 250 may include a pointing stick (nub) instead of trackball 252, or may even be a touch pad (additionally providing the functionality of clicking device 260).

According to some embodiments, not depicted in the figures, first unit 202 and/or second unit 204 may additionally include navigation and selection keys (e.g. first unit 202 may include up and down arrow keys and second unit 204 may include left and right arrow keys as well as a key providing the “click” functionality of a mouse button), which provide navigation capabilities within a typed text (e.g. displayed on a smartphone screen, as described below). In such embodiments, use of a pointing and clicking assembly, as described above in the description of FIGS. 1D and 1E, is unnecessary (although pointing device 250 and/or clicking device 260 may still be employed if desired).

Referring also to FIG. 2, a driver is depicted driving in a car including steering wheel 100 with keyboard 200 and the pointing and clicking assembly (i.e. devices 250 and 260) installed on steering wheel 100. The driver is depicted typing on keyboard 200. The typed text is shown on the screen of a smartphone 300 (e.g. the driver's smartphone) installed above steering wheel 100, as described below.

More specifically, keyboard 200 and the pointing and clicking assembly may be configured to be used in conjunction with a mobile computational device, such as smartphone 300, and a (e.g. downloadable) keyboard associated app. Each of units 202 and 204, and devices 250 and 260, is configured to be communicatively associated with smartphone 300. According to some embodiments, each of units 202 and 204, and devices 250 and 260, may include a wireless communication unit (e.g. a Bluetooth transceiver), thereby allowing to communicatively associate units 202 and 204, and devices 250 and 260, with smartphone 300. According to some embodiments, units 202 and 204, and devices 250 and 260, may be powered by batteries. According to some embodiments, the batteries may replaceable and/or rechargeable. According to some embodiments, units 202 and 204, and devices 250 and 260, may be powered by cable (e.g. a micro USB power cable or a USB power cable), which may be connected, e.g. to smartphone 300 or a power outlet in the car.

Additionally, or alternatively, according to some embodiments, 202 and 204, and devices 250 and 260, may be communicatively associated with smartphone 300 by wire (in which case, according to some embodiments, no batteries are necessary).

In use, and as depicted in FIG. 2, a driver uses their right hand to type on first unit 202 and their left hand to type on second unit 204. (In the following, first unit 202 may also be referred to as “right hand unit” and second unit 204 may also be referred to as “left hand unit”.) The driver may type on the front surfaces of first unit 202 and second unit 204 with the palms of their hands gripping wheel 102 in a normal manner for driving.

The driver thus types blindly on the keyboard 200 with the keys facing away from the driver. However, due to the layout of the keys on keyboard 200 being a mirror of the layout of the keys on a QWERTY keyboard (when keyboard 200 is properly mounted on a steering wheel (as depicted in FIGS. 1A, 1F, and 2), the keys are arranged in a QWERTY keyboard layout relative to the driver (up to the keyboard being partitioned into two units (first unit 202 and second unit 204), which are spaced apart).

That is, when properly mounted on a steering wheel, each key in keyboard 200 is positioned where the driver expects to find the key based on a mental image they have of a keyboard. This mental image is drawn from visual memory, and, as such, corresponds to the type of keyboard the driver uses daily. In this case, as non-limiting example intended to facilitate the description, it is assumed that the driver uses a QWERTY keyboard on a daily basis, such as a virtual QWERTY keyboard on their smartphone, the QWERTY keyboard of their laptop computer, and/or the QWERTY keyboard of their desktop computer.

While keyboard 200 is shown as configured for drivers who in everyday life use a QWERTY keyboard, it is to be understood that the scope of the disclosure is not limited in this respect. Indeed, the layouts of the steering wheel keyboards of the present disclosure may be based on alternatives to the QWERTY keyboard layout, such as, for example, the Dvorak and Colemak keyboard layouts with the key layout of the respective steering wheel keyboard being a mirror image thereof, in the same way as explained above with respect to keyboard 200.

Further, the layouts of the steering wheel keyboards of the present disclosure may be based on keyboard layouts designed for languages other than English. Non-limiting examples include the Latin alphabet AZERTY keyboard layouts and QWERTZ keyboard layouts, which are employed by French speakers and in central Europe, respectively. Again, the guiding principle is the mirror inversion of a standard keyboard. Thus, for a steering wheel keyboard based on an AZERTY keyboard, when the two units thereof are considered side-by-side, with the left hand unit positioned to the right of the right-hand unit, the letters ‘a’ and ‘p’ are “switched”, similarly the letters, ‘z’ and ‘o’ are “switched”, and so on.

Finally, it is emphasized that the steering wheel keyboards of the present disclosure are not limited to Latin alphabet-based keyboards. Using the guiding principle of the mirror inversion of a keyboard and the partitioning of the keyboard into two units (as described above with respect to a QWERTY-based keyboard), the steering wheel keyboards of the present disclosure may be adapted to essentially any language, whether Russian, Arabic, Korean, or even Chinese, to name a few non-limiting examples.

It is to be understood that different embodiments of keyboard 200 may differ from one another in the sizes thereof, the sizes of the keys, and the spacings between the keys. According to some embodiments, keyboard 200 may be manufactured in different sizes and a driver may select the size of units 202 and 204, which is most convenient for them. For example, a driver whose hands are small may prefer to use a keyboard with smaller keys, which are more densely spaced. Further, taking into account the fact the shapes of steering wheels vary from one auto manufacturer to another, and sometimes even significantly, it is contemplated that different specific embodiments of keyboard 200 may be configured for use with steering wheel(s) of a specific car manufacturer or even model.

According to some embodiments, and as depicted in FIGS. 1B and 1C, the top surface of each of the ‘f’ and ‘j’ keys may have imprinted thereon a raised impression of the respective letter. The raised impressions allow tactile recognition of the keys, thereby serving the same function as the ridges on the ‘f’ and ‘j’ keys on a QWERTY laptop keyboard or desktop computer keyboard. According to some embodiments, not depicted in the figures, each letter on the keyboard may have imprinted thereon the letter, thereby facilitating tactile identification of the key.

According to some embodiments, each of the ‘f’ and ‘j’ keys may be notched, such as to allow a driver to easily distinguish these keys from the rest of the keys and thereby confirm or establish the positionings of their fingers on each of units 202 and 204. According to some embodiments, and as depicted in FIGS. 1B and 1C, the ‘j’ key may include a notch 272 (i.e. a rounded depression) on the right edge thereof and the ‘f’ key may include a notch 274 on the left edge thereof.

Referring again to FIG. 2, smartphone 300 is shown horizontally mounted above steering wheel 100 in front of the driver. According to some embodiments, smartphone 300 may be detachably mounted on a stand 310 (e.g. a mount; only the top of stand 310 is visible in FIG. 2) installed behind steering wheel 100. The mounting mechanism of smartphone 300 on stand 310 may be e.g. magnetic or mechanical. The base of stand 310 may be affixed onto a dashboard 320 or a front windshield 330 of the car, e.g. by glue or vacuum.

Stand 310 is configured, and, optionally, may be adjustable (i.e. raised or lowered), such that when smartphone 300 is mounted thereon, the driver's view of the road is, or practically is, unobstructed (by smartphone 300). In this regard, it is noted that although in FIG. 2 the bottom of smartphone 300 screen is hidden from view by steering wheel 100, from the perspective of the driver (which does not coincide with the vantage point at which FIG. 2 is drawn) smartphone 300 screen is fully visible. In order to read text on smartphone 300 screen, the driver needs to lower their gaze at most only slightly, and, in particular, less than is required to read the dashboard meters (e.g. the speed meter) and symbols.

The (keyboard-associated) app functionally associates keyboard 200 with smartphone 300. In embodiments also including the pointing and clicking assembly (i.e. devices 250 and 260), the app functionally may further associate the pointing and clicking assembly with smartphone 300. The app may be configured to display on the screen of smartphone 300 text typed on keyboard 200. The font size may be large (e.g. 18 point, 20 point, or larger) by default in order to ensure that the driver does not, even inadvertently, lean towards smartphone 300 to read text displayed thereon. According to some embodiments, the app may be configured to display on the screen of smartphone 300 in a customized format text from a third-party app, such as an e-mail app or a messaging app. The customized format may incorporate a horizontal layout (i.e. landscape orientation). In particular, the keyboard-associated app may be configured to adapt text, originally set in a vertical layout, to a horizontal layout. According to some embodiments, the keyboard-associated app may be configured to maximize the area of the screen devoted to typed text.

According to some embodiments, the keyboard-associated app may further include a graphical user interface (GUI) 350, allowing to: send or post a typed text, e.g. as an email or a text message, or e.g. as a post on Facebook or Twitter, open an email or text message, reply to an email, a text message, or a post, attach a file to an outgoing message, and so on. The GUI may be in the form of a sidebar.

According to some embodiments, the keyboard-associated app may include predictive text (i.e. auto-complete) capabilities and/or auto-correct capabilities.

Navigation and selection keys on units 202 and 204, and/or the pointing and clicking assembly, may be used to maneuver on screen a cursor (i.e. pointer), thereby providing mouse-like capabilities and allowing to navigate between different parts in a typed text. The navigation and selection keys, and/or the pointing and clicking assembly. may further be used to navigate between icons in the GUI. According to some embodiments, the app may be configured to display the GUI only if the cursor is maneuvered to e.g. the right edge of the screen. According to some such embodiments, the GUI may take up all of the screen.

According to some embodiments, the keyboard-associated app may also be controlled by voice, optionally, using the speech recognition capabilities provided by a software agent of the smartphone operating system (e.g. Siri in iPhone or Google Assistant in an Android phone). According to some embodiments, commands, such as send, reply, and forward, may be entered orally. According to some embodiments, the app may allow orally dictating a text. According to some embodiments, the dictated text may be displayed on the screen of the smartphone 300, e.g. in real-time. The driver may then use keyboard 200 and the pointing and clicking assembly to edit and correct dictation errors in the text, e.g. prior to sending the text.

Nevertheless, even with the option of dictation, the utility of keyboard 200 is not limited to editing and correcting a dictated text. There are in fact many everyday instances wherein typing may be preferred by a driver. For example, (i) when passengers are present who may be engaged in conversation, so that dictation is impossible; (ii) when passengers are present but the driver wishes to keep the contents of the typed text private; or (iii) when the car windows are open so that conditions may be too noisy for dictation (or at least reliable dictation).

The keyboard-associated app may include safety features: According to some embodiments, in some semi-autonomous cars (e.g. conditional automation as classified by the Society of Automotive Engineers (SAE)), the app may allow typing on keyboard 200 (in the sense that typing is actually registered by smartphone 300) only when the automation system controls the speed and the steering (that is, in driving conditions wherein full control by the driver is not required). According to some embodiments, in advanced semi-autonomous cars (e.g. high automation as classified by the SAE), the app may allow typing on keyboard 200 only when the car is in self-driving mode and the automated driving system determines that no driver oversight is necessary. According to some embodiments, the app may be configured to disable typing on keyboard 200 when the speed of the car exceeds a maximum speed.

According to some embodiments, the maximum speed may be set to the maximum lawful speed (i.e. maximum speed limit) established in a jurisdiction (i.e. country or state). According to some embodiments, the app may be configured to adjust the maximum speed to equal the maximum lawful speed in an area in which the car is presently driven. For example, when driving inside city limits, the app may set the maximum speed to equal the maximum lawful speed for city streets, while when driving outside city limits, the app may set the maximum speed to equal the maximum lawful speed for highways. According to some embodiments, the app may be configured to set the maximum speed to equal the maximum lawful speed assigned to a specific road or lane along which the car is presently driven.

According to some embodiments, the maximum speed may be about 50 km/h, about 35 km/h, or even about 20 km/h. Each possibility corresponds to separate embodiments.

According to some embodiments, the keyboard-associated app may be functionally associated with a GPS in the smartphone. The app may be configured to obtain the driving speed based on the GPS readings. According to some embodiments, the app may be configured to receive the instantaneous driving speed from the car computer.

According to some embodiments, the keyboard-associated app may be configured to allow reprogramming the keys of keyboard 200. That is, the app may be configured to allow a driver to assign a letter (and number or symbol) to each key. In such embodiments, the keys may be smooth and 3D stickers (i.e. bulging stickers), shaped as letters, numbers, and/or symbols, may be attached to the keys to facilitate tactile recognition of the keys.

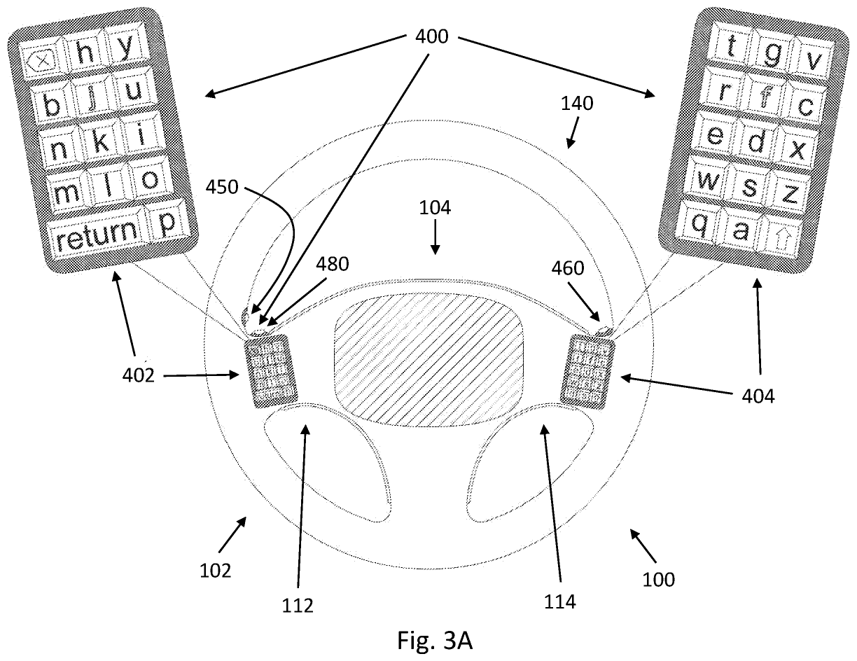

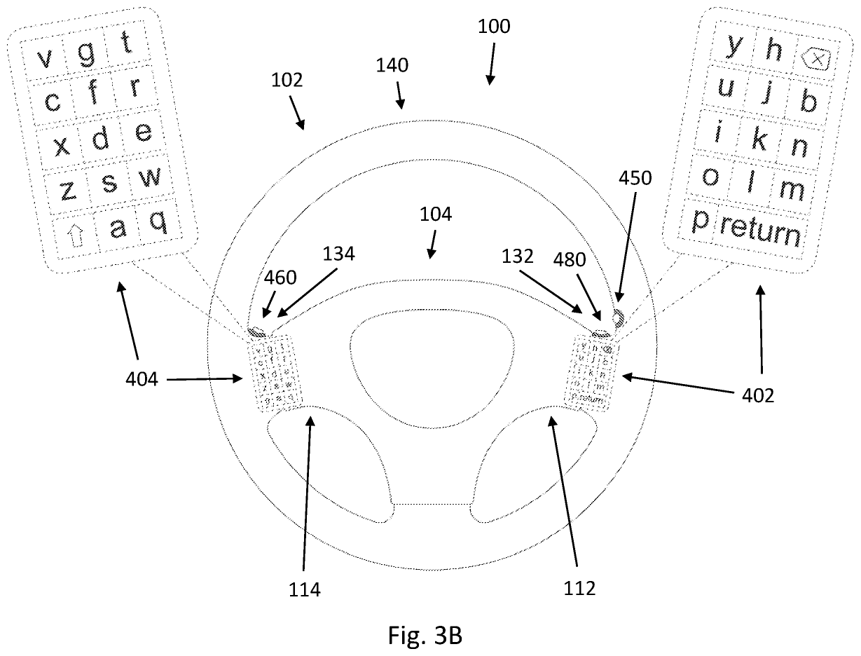

As explained above, a driver who has a mental image of the keyboards they use in everyday life (e.g. the virtual keyboard on their smartphone or the keyboard of their laptop) does not need to memorize the relative locations of the keys in order to type on keyboard 200 while driving. That is, the design of keyboard 200 is configured to facilitate use thereof by people who have formed a mental picture of the keyboards they use in everyday life. In contrast, some people do not form a mental picture of a keyboard in their mind but may nevertheless remember the locations of the keys due to tactile memory (in the sense of muscle memory). The steering wheel keyboard of FIGS. 3A and 3B is configured to facilitate use thereof by people who have acquired muscle memory allowing them to blind-type on the keyboards they use in everyday life.

Thus, according to an aspect of some embodiments, depicted in FIGS. 3A and FIG. 3B, there is provided a steering wheel keyboard 400 for a steering wheel. FIG. 3A presents a schematical back view of steering wheel 100 with keyboard 400 mounted thereon, according to some embodiments. Keyboard 400 is similar to keyboard 200 and includes a first unit 402, mounted on first side-arm 112, and a second unit 404, mounted on second side-arm 114. FIG. 3B presents a schematic front view of steering wheel 100 with keyboard 400 mounted thereon, according to some embodiments. Even though units 402 and 404 would not be visible in a front view (and would not be visible to a seated driver), they are nevertheless outlined (in a dashed line) to facilitate the description.

According to some embodiments, units 402 and 404 are attachable onto the backside of steering wheel 100 (e.g. using Velcro), essentially as described with respect to units 202 and 204. Similarly to units 202 and 204, the precise positioning of units 402 and 404 on the backside of steering wheel 100 may be adjustable.

First unit 402 includes three columns of letters keys, which are arranged in a first pattern. According to some embodiments, the first pattern may be obtained from the arrangement of letter keys on a right half of a standard computer keyboard (QWERTY in FIG. 3A) by a 90° (e.g. between 81° and 99° or even between 72° and 108°) clockwise rotation. Optionally, and as depicted in FIG. 3A, (following the rotation) the columns may be slightly vertically shifted with respect to one another, so as to afford a more compact layout of the keys. Second unit 404 includes three columns of letter keys, which are arranged in a second pattern. According to some embodiments, the second pattern may be obtained from the arrangement of letters keys on a left half of a standard computer keyboard (QWERTY in FIG. 3A) by a 90° (e.g. between 81° and 99° or even between 72° and 108°) anti-clockwise rotation. Optionally, and as depicted in FIG. 3A, (following the rotation) the columns may be slightly vertically shifted with respect to one another, so as to afford a more compact layout of the keys.

A driver with their hands disposed on steering wheel 100 in a driving posture, essentially as depicted in FIG. 2, such that the right hand fingertips are positioned behind first side-arm 112 and the left hand fingertips are positioned behind second side-arm 114, will have the right hand fingers positioned on the keys of first unit 402, and the left hand fingers positioned on the keys of second unit 404. This positioning of the fingers on the keys is similar to when typing on a laptop keyboard or desktop computer keyboard.

More specifically, according to some embodiments, in each hand the index finger will be positioned above the middle finger, which will be positioned above the ring finger, which will be positioned above the little finger. With the left hand so disposed, the left index figure may be positioned to allow striking: (i) when sufficiently extended, the keys ‘t’ and ‘r’, as when typing on a standard (e.g. laptop or desktop) QWERTY keyboard; (ii) when slightly less extended, the keys ‘g’ and ‘f’, as when typing on a standard QWERTY keyboard; and (iii) when sufficiently retracted (or folded), the keys ‘v’ and ‘c’, as when typing on a standard QWERTY keyboard. Similarly, with the left hand so disposed, the left middle figure may be positioned to allow striking: (i) when sufficiently extended, the keys ‘r’ and ‘e’, as when typing on a standard QWERTY keyboard; (ii) when slightly less extended, the keys ‘f’ and ‘d’, as when typing on a standard QWERTY keyboard; and (iii) when sufficiently retracted (or folded), the keys ‘c’ and ‘x’, and so on with respect to the ring and little fingers.

Similarly, according to some embodiments, with the right hand so disposed, the right index figure may be positioned to allow striking: (i) when sufficiently extended, the keys ‘y’ and ‘u’, as when typing on a standard (e.g. laptop or desktop) QWERTY keyboard; (ii) when slightly less extended, the keys ‘h’ and ‘j’, as when typing on a standard QWERTY keyboard; and (iii) when sufficiently retracted (or folded), the ‘b’ key, as when typing on a standard QWERTY keyboard, and so on with respect to the middle ring and little fingers.

In other words, when keyboard 400 is properly mounted on a steering wheel, with the driver holding the steering wheel, as described above, each letter key in keyboard 400 is positioned where the driver expects to find the key based on tactile memory from everyday use of a standard QWERTY keyboard.

According to some embodiments, and as depicted in FIGS. 3A and 3B, keyboard 400 does not include a space key nor a ‘123’ key. In such embodiments, keyboard 400 may include a complementary unit 480 for performing these functions. Similarly to clicking device 260, complementary unit 480 is configured to be controlled by the thumb (as a non-limiting example, in FIGS. 3A and 3B, the right thumb). According to some embodiments, complementary unit 480 includes a push-button on a complementary unit surface (both not numbered), which may be essentially similar to clicking device surface 264. According to some embodiments, to add a space in a typed text, the push-button of complementary unit 480 may be clicked (i.e. pressed and quickly released), while to toggle between the letters keyboard layout and the numbers and symbols keyboard layout the push-button may be pressed for a longer duration. Transferring some functions to a thumb-controlled unit, such as complementary unit 480, allows decreasing the sizes of the primary units (e.g. first unit 402 and second unit 404) attached to the backside of the steering wheel, which may facilitate mounting thereof on steering wheels whose side-arms are narrow. Alternatively, transferring some functions to a thumb-controlled unit, such as complementary unit 480, allows increasing the spacing between adjacent keys on the primary units, which may facilitate typing by drivers having larger or thicker fingers.

Also indicated in FIGS. 3A and 3B is a pointing and clicking assembly including a pointing device 450 and a clicking device 460, which may be similar to pointing device 250 and clicking device 260. In FIGS. 3A and 3B pointing device 450 is shown positioned on wheel upper portion 140 slightly above first corner 132, such as to allow accommodating complementary unit 480 in first corner 132.

While the keyboard 400 is shown as configured for drivers who in everyday life use a QWERTY keyboard, the scope of the disclosure covers substantially any type of keyboard, in any language, having the same dimensions as standard QWERTY keyboard and having a similar number of keys. Non-limiting examples include all of the examples mentioned above in the discussion of the scope of the visual memory-based steering wheel keyboards.

According to an aspect of some embodiments, not depicted in the figures, there is provided a steering wheel keyboard, which may be similar to keyboard 200 or keyboard 400 but differs therefrom in that the right hand and left hand units thereof may be larger and include additional keys such as navigation and selection keys, number keys, symbol keys, and/or special function keys. According to some embodiments, the keyboard is similar to keyboard 200 and includes a first unit and second a unit, which are similar to first unit 202 and second unit 204, respectively, but which may differ as described below. According to some embodiments, the first unit and the second a unit may differ from first unit 202 and second unit 204 at least in additionally including number keys (and in not including the ‘123’ key). Five number keys ‘1’, ‘2’, ‘3’, ‘4’, and ‘5’ may be included in the second unit, being arranged in a row above the letter keys (on the second unit) in decreasing numerical order from left to right. Five number keys ‘6’, ‘7’, ‘8’, ‘9’, and ‘0’ may be included in the first unit, being arranged in a row above the letter keys (on the first unit). The key ‘0’ is leftmost in the row with the rest of the keys being arranged in decreasing numerical order from left to right. Additionally, or alternatively, according to some embodiments, the first unit and the second a unit may differ from first unit 202 and second unit 204 at least in additionally including special function keys, such as keys configured to open (i.e. display) a received message, send a typed message, and delete a message.

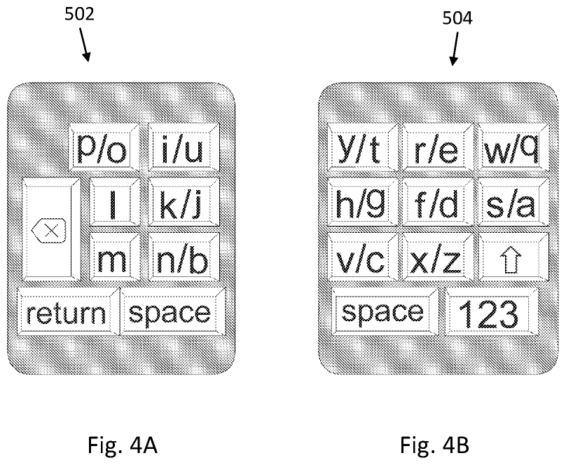

According to an aspect of some embodiments, there is provided a keyboard for a steering wheel. The keyboard includes a first unit 502, schematically depicted in FIG. 4A, and a second unit 504, schematically depicted in FIG. 4B. More specifically, FIG. 4A presents a front view of first unit 502, according to some embodiments. FIG. 4B presents a front view of second unit 504, according to some embodiments. First unit 502 is configured to be mounted on a right side-arm of a steering wheel on the backside thereof, essentially as depicted with respect to first unit 202 in FIG. 1A. Second unit 504 is configured to be mounted on a left side-arm of a steering wheel on the backside thereof, essentially as depicted with respect to second unit 204 in FIG. 1A. Here the use of ‘right’ and ‘left’ refers to the handedness as would be defined by a seated driver facing the steering wheel.

Considering both first unit 502 and second unit 504 together, with second unit 504 positioned to the right of first unit 502, it is seen that the two units constitute complementary parts of a (half) keyboard (or keypad) whose keys are arranged in a mirror image of a half-QWERTY keyboard. More specifically, all the letter keys except for the ‘l’ and ‘m’ correspond to a pair of letters. According to some embodiments, to type the first letter (e.g. ‘q’ on the ‘q/w’ key), the key may be clicked once, while, to type the second letter (e.g. ‘w’ on the q/w′ key), the key may be quickly clicked twice or held down longer.

As compared, to keyboards 200 and 400, the keyboard includes fewer keys. Accordingly, units 502 and 504 may be smaller in comparison to units 202 and 204, and 402 and 404.

Alternatively, according to embodiments, the keys on units 502 and 504 may be bigger and/or less densely spaced, as compared to the keys on units 202 and 204, and 402 and 404.

According to an aspect of some embodiments, there is provided a steering wheel of a car including a keyboard on a backside of the steering wheel. The keyboard includes a first unit and a second unit mounted on or built-in into a backside of a right side-arm of the steering wheel and a left side-arm of the steering wheel, respectively. The arrangement of keys on each of the two units may differ from the arrangement of keys in each of the two units of keyboard 200, 400, and 500, and may potentially have to be memorized by a driver prior to use. The advantage offered by the keyboard (like keyboards 200, 400, and 500) is that it is hidden from view from a seated driver. Hence, the driver is forced to blindly type on the keyboard and so may keep their eyes on the road, while typing.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. A keyboard for a steering wheel of a car, the keyboard comprising a first unit and a second unit, which are configured to be mounted on a back of a steering wheel on a right side and a left side of the steering wheel, respectively;
wherein the first unit is positioned and configured so as to enable a driver to type thereon using a right hand thereof, while the right hand is grasping the steering wheel, and the second unit is positioned and configured so as to allow a driver to type thereon using a left hand thereof, while the left hand is grasping the steering wheel; and
wherein (i) the first and second unit constitute complementary parts of a keyboard whose keys are arranged in a mirror image of a standard computer keyboard or virtual smartphone keyboard, or (ii) the first unit comprises three columns of letters keys arranged in a first pattern, which is related to the arrangement of letter keys on a right half of a standard computer keyboard by about 90° clockwise rotation, and the second unit comprises three columns of letter keys arranged in a second pattern, which is related to the arrangement of letters keys on a left half of a standard computer keyboard by about 90° anti-clockwise rotation;
the keyboard being thereby configured to facilitate blind typing thereon by a seated driver.

2. The keyboard of claim 1, wherein the first and second units constitute complementary parts of a keyboard whose keys are arranged in a mirror image of a QWERTY keyboard.

3. The keyboard of claim 1, wherein the first unit is positioned and configured to enable the driver to type thereon using one or more of the second to fifth digits of the right hand, and wherein the second unit is positioned and configured to enable the driver to type thereon using one or more of the second to fifth digits of the left hand.

4. The keyboard of claim 1, wherein the first unit is configured to be mounted on the back of the steering wheel on a right side-arm of the steering wheel, and the second unit is configured to be mounted on the back of the steering wheel on a left side-arm of the steering wheel.

5. The keyboard of claim 1, wherein one or more letter keys on each of the first unit and the second unit have imprinted thereon a raised impression of the respective letter, thereby facilitating tactile identification of the letter key.

6. The keyboard of claim 1, configured to be communicatively associated with a mobile computational device.

7. (canceled)

8. The keyboard of claim 6, wherein the first unit and/or the second unit comprises navigation and selection keys; and/or wherein the first unit and/or the second unit comprise specialized function keys comprising one or more of ‘read message’, ‘send message’, and ‘delete message’.

9. (canceled)

10. (Cancelled)

11. The keyboard of claim 1, wherein each of the first and second units is removably mountable on the back of the steering wheel, and wherein each of the first and second units is flexible so as to conform to a range of shapes and/or dimensions of steering wheel backsides.

12. (canceled)

13. The keyboard of claim 1, wherein each of the first and second units is functionally associated with a car computer via electronic circuitry in the first and second units.

14. The keyboard of claim 13, wherein the electronic circuitry is configured to receive from the car computer driving parameters and based thereon enable or disable typing on the keyboard.

15. (canceled)

16. The keyboard of claim 1, wherein the first unit and second unit are interconnected.

17. (canceled)

18. A steering wheel for a car comprising the keyboard of claim 1, wherein the first and second units are built-in into the right side-arm and left side-arm backsides, respectively.

19. A keyboard assembly for a steering wheel of a car, the keyboard assembly comprising:
a keyboard according to claim 1, wherein the keyboard is configured to be communicatively associated with a mobile computational device; and
the mobile computational device, communicatively associated with the keyboard and configured to display on a screen thereof text typed on the keyboard.

20. (canceled)

21. (canceled)

22. A keyboard assembly for a steering wheel for a car, the keyboard assembly comprising:
a keyboard according to claim 1, wherein the keyboard is configured to be communicatively associated with a mobile computational device; and
a computer-readable storage medium having stored thereon software, which when executed by a processor of the mobile computational device communicatively associated with the keyboard, causes the mobile computational device to display on a screen thereof text typed on the keyboard.

23. The keyboard assembly of claim 22, wherein the mobile computational device is a smartphone.

24. The keyboard assembly of claim 23, wherein the first unit and/or the second unit comprise navigation and selection keys, and wherein the software is further configured to enable use of at least some of the smartphone functions using the navigation and selection keys.

25. (canceled)

26. (canceled)

27. (canceled)

28. (canceled)

29. (canceled)

30. (canceled)

31. (canceled)

32. (canceled)

33. A keyboard assembly for a steering wheel of a car, the keyboard assembly comprising:
a keyboard according to claim 1, wherein the keyboard is configured to be communicatively associated with a mobile computational device; and
a stand installable between a steering wheel and a front windshield of a car, the stand being configured for detachably mounting thereon of the mobile computational device, such that a seated driver's view of a road through the front windshield is unobstructed, or minimally obstructed.

34. The keyboard assembly of claim 33, wherein the mobile computational device is a smartphone and wherein the stand is configured for horizontal mounting of the smartphone.

35. The keyboard assembly of claim 33, wherein the stand is configured to be installable on a dashboard of the car and/or on the front windshield.

36. (canceled)

37. (canceled)

38. A keyboard assembly for a steering wheel of a car, the keyboard assembly comprising:
a keyboard according to claim 1, wherein the keyboard is configured to be communicatively associated with a mobile computational device; and
a pointing device configured to be communicatively associated with the mobile computational device and mountable on a steering wheel such that as to be controllable by a thumb of one of the hands of the driver when the second to fifth digits of the hand are positioned on the one of the first and second units, the pointing device having at least computer mouse navigation capabilities.

39. (canceled)

40. (canceled)

41. (canceled)
